(19) United States
(12) Patent Application Publication
(10) Pub. No.: US 2021/0387391 A1
(43) Pub. Date: Dec. 16, 2021

(54) INDEPENDENT STARTUP MODE FOR INJECTION MOLDING

(71) Applicant: IMFLUX INC., Hamilton, OH (US)

(72) Inventors: Brandon Michael Birchmeier, Morrow, OH (US); Brian Matthew Burns, Mason, OH (US); Gene Michael Altonen, West Chester, OH (US)

(21) Appl. No.: 17/326,538

(22) Filed: May 21, 2021

Related U.S. Application Data
(60) Provisional application No. 63/039,050, filed on Jun. 15, 2020.

(51) Int. Cl. B29C 45/76; B29C 45/77

(52) U.S. Cl. CPC B29C 45/766; B29C 45/77; B29C 2945/76257; B29C 2945/76006; B29C 2945/76936; B29C 2945/7618; B29C 2945/76381; B29C 2945/76558; B29C 2945/7611

(57) ABSTRACT

Systems and approaches for controlling an injection molding machine having a mold forming a mold cavity and being controlled according to an injection cycle include injecting a molten polymer into the mold cavity according to a startup profile. A first sensor is used to measure at least one variable during the startup profile. The startup profile is terminated upon the at least one variable exceeding a first threshold. The molten polymer is then injected into the mold cavity according to a primary injection profile.

### CROSS REFERENCE TO RELATED APPLICATIONS

This application claims the benefit of U.S. Provisional Application No. 63/039,050, filed on Jun. 15, 2020, the entirety of which is herein expressly incorporated by reference.

### FIELD OF THE DISCLOSURE

The present disclosure relates generally to injection molding and, more particularly, to approaches for controlling injection molding machines using startup mode mechanisms.

### BACKGROUND

Injection molding is a technology commonly used for high-volume manufacturing of parts constructed of thermoplastic materials. During repetitive injection molding processes, a thermoplastic resin, typically in the form of small pellets or beads, is introduced into an injection molding machine which melts the pellets under heat and pressure. In an injection cycle, the molten material is forcefully injected into a mold cavity having a particular desired cavity shape. The injected plastic is held under pressure in the mold cavity and is subsequently cooled and removed as a solidified part having a shape closely resembling the cavity shape of the mold. A single mold may have any number of individual cavities which can be connected to a flow channel by a gate that directs the flow of the molten resin into the cavity. A typical injection molding procedure generally includes four basic operations: (1) heating the plastic in the injection molding machine to allow the plastic to flow under pressure; (2) injecting the melted plastic into a mold cavity or cavities defined between two mold halves that have been closed; (3) allowing the plastic to cool and harden in the cavity or cavities while under pressure; and (4) opening the mold halves and ejecting the part from the mold.

In many systems, the machine may experience a power-off scenario in which it is not in operation for a duration of time (e.g., five minutes to several hours or days). For example, the machine may experience a fault requiring repairs, may need to be adjusted and/or serviced, or the facility may experience a loss of electrical power, among other examples. In such situations, this down time may alter the characteristics of the machine and/or the polymer intended to be injected. For example, some materials may experience a change in viscosity during such a downtime. In any event, upon resuming operation of the injection molding machine, care must be afforded to avoid inadvertently damaging the machine.

### SUMMARY

Embodiments within the scope of the present invention are directed to the control of injection molding machines to produce repeatably consistent parts. Systems and approaches for controlling an injection molding machine having a mold forming a mold cavity and being controlled according to an injection cycle include injecting a molten polymer into the mold cavity according to a startup profile. A first sensor is used to measure at least one variable during the startup profile. The startup profile is terminated upon the at least one variable exceeding a first threshold. The molten polymer is then injected into the mold cavity according to a primary injection profile. In some examples, the approaches further include the step of continuing to inject the molten polymer into the mold cavity according to the startup profile if the at least one variable does not exceed the first threshold value.

In some approaches, the startup profile includes injecting a plurality of shots of molten polymer into the mold cavity, each of the plurality of injected shots being injected according to distinct, pre-determined injection velocity or injection pressure setpoints. In some forms, the at least one variable is in the form of a quantity of shots of molten polymer injected into the mold cavity. In these examples, the threshold value is at least two five shots. In these examples, each of the at least two shots may be injected according to distinct, pre-determined injection velocity or injection pressure setpoints. In other forms, the at least one variable comprises a time required to reach a desired operational level. In these examples, the desired operational level may be in the form of a cavity pressure or a virtual cavity pressure.

In some examples, the approaches further include the step of triggering an alarm if the at least one variable fails to exceed the first threshold after a designated quantity of successive shots in the startup profile.

In accordance with another aspect, an injection molding machine includes an injection unit having a mold forming a mold cavity and a screw that moves from a first position to a second position, a controller adapted to control operation of the injection molding machine according to an injection cycle, and a sensor coupled with the injection molding machine and the controller. The injection unit is adapted to receive and inject a molten plastic material into the mold cavity via the screw to form a molded part. The sensor is adapted to measure at least one variable during a startup profile. The controller is further adapted to commence injection of the molten polymer into the mold cavity according to the startup profile, terminate the startup profile upon the at least one variable sensed by the sensor exceeding a first threshold, and commence injection of the molten polymer into the mold cavity according to a primary injection profile.

In accordance with yet another aspect, an approach for controlling an injection molding machine having a mold forming a mold cavity is provided. The injection molding machine is controlled according to an injection cycle, and includes determining a duration of downtime of the injection molding machine, and configuring the injection molding machine to operate according to a startup profile according to the duration of downtime. A molten polymer is injected into the mold cavity according to the startup profile. A first sensor is used to measure at least one variable during the startup profile. The approach further includes determining whether the at least one variable exceeds a threshold value. If the at least one variable exceeds the threshold value, the approach proceeds to terminate the startup profile.

In accordance with yet another aspect, a non-transitory computer-readable storage medium is adapted to store processor-executable instructions that, when executed, cause one or more processors to inject a molten polymer into the mold cavity according to a startup profile. Further, the one or more processors measure, using a first sensor, at least one variable during the startup profile, terminate the startup profile upon the at least one variable exceeding a first threshold, and inject the molten polymer into the mold cavity according to a primary injection profile.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale. For example, the dimensions and/or relative positioning of some of the elements in the figures may be exaggerated relative to other elements to help to improve understanding of various embodiments of the present invention.

FIG. 1 illustrates a schematic view of an example first injection molding machine having a controller coupled therewith in accordance with various embodiments of the present disclosure;

FIG. 2 illustrates an example flow diagram of a startup mode process for an injection molding machine in accordance with various embodiments of the present disclosure.

### DETAILED DESCRIPTION

Generally speaking, aspects of the present disclosure include systems and approaches for controlling an injection molding machine where operational parameters are adjusted to ensure a consistent volume of injected plastic at a consistent molten material viscosity. In these systems and approaches, upon the injection molding machine experiencing a downtime event, the injection molding machine may operate in a startup mode or profile whereby operational parameters are adjusted to account for changes in material and/or machine characteristics. The injection molding machine may operate according to this startup profile until it determines it may resume normal operation according to a primary injection profile. For example, the injection molding machine may operate according to a startup profile until it is determined that the molten plastic material has reached a desired viscosity. As a result, if the machine and/or the material are colder than ideal temperatures, the machine may operate in an initial manner to slowly and safely increase operating temperatures. Other examples are possible.

In some examples, the injection molding machine may have a fixed startup profile whereby the injection molding machine is operated according to specific, previously-input parameters. However, in some examples, the injection molding machine may have a dynamic startup profile whereby, based on sensed values, the injection molding machine may modify the startup profile as needed. Such calculations may be performed via any number of suitable sensors or sensing mechanisms.

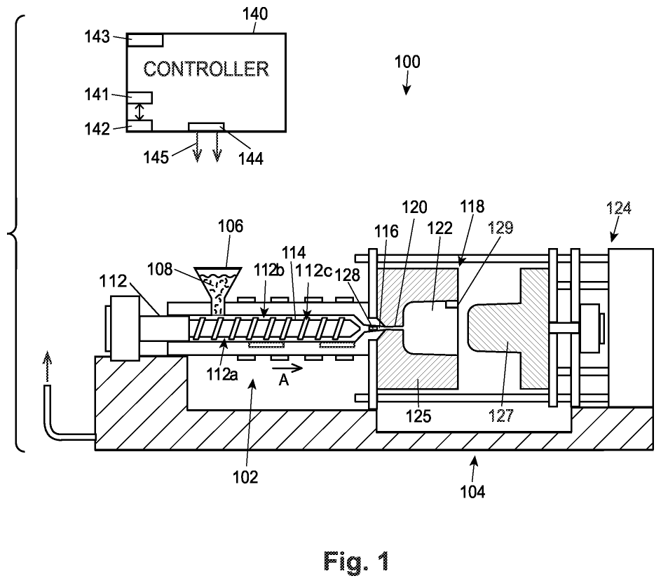

Turning to the drawings, an injection molding process is herein described. The approaches described herein may be suitable for electric presses, servo-hydraulic presses, hydraulic presses, and other known machines. As illustrated in FIG. 1, the injection molding machine 100 includes an injection unit 102 and a clamping system 104. The injection unit 102 includes a hopper 106 adapted to accept material in the form of pellets 108 or any other suitable form. In many of these examples, the pellets 108 may be a polymer or polymer-based material. Other examples are possible.

The hopper 106 feeds the pellets 108 into a heated barrel 110 of the injection unit 102. Upon being fed into the heated barrel 110, the pellets 108 may be driven to the end of the heated barrel 110 by a reciprocating screw 112 that is movable from a first, original position 112a to a number of subsequent positions for inject the first, second, third, and/or any subsequent shots. The heating of the heated barrel 110 and the compression of the pellets 108 by the reciprocating screw 112 causes the pellets 108 to melt, thereby forming a molten plastic material or polymer 114. The molten plastic material 114 is typically processed at a temperature selected within a range of about 130° C. to about 410° C. (with manufacturers of particular polymers typically providing injection molders with recommended temperature ranges for given materials).

The reciprocating screw 112 advances forward from a first position 112a to a second position 112b and forces the molten plastic material 114 toward a nozzle 116 to form a shot of plastic material that will ultimately be injected into a mold cavity 122 of a mold 118 via one or more gates 120 which direct the flow of the molten plastic material 114 to the mold cavity 122. In other words, the reciprocating screw 112 is driven to exert a force on the molten plastic material 114. In other embodiments, the nozzle 116 may be separated from one or more gates 120 by a feed system (not illustrated). The mold cavity 122 is formed between the first and second mold sides 125, 127 of the mold 118 and the first and second mold sides 125, 127 are held together under pressure via a press or clamping unit 124.

The press or clamping unit 124 applies a predetermined clamping force during the molding process which is greater than the force exerted by the injection pressure acting to separate the two mold halves 125, 127, thereby holding together the first and second mold sides 125, 127 while the molten plastic material 114 is injected into the mold cavity 122. To support these clamping forces, the clamping system 104 may include a mold frame and a mold base, in addition to any other number of components, such as a tie bar.

Once the shot of molten plastic material 114 is injected into the mold cavity 122, the reciprocating screw 112 halts forward movement. The molten plastic material 114 takes the form of the mold cavity 122 and cools inside the mold 118 until the plastic material 114 solidifies. Upon solidifying, the press 124 releases the first and second mold sides 115, 117, which are then separated from one another. The finished part may then be ejected from the mold 118. The mold 118 may include any number of mold cavities 122 to increase overall production rates. The shapes and/or designs of the cavities may be identical, similar to, and/or different from each other. For instance, a family mold may include cavities of related component parts intended to mate or otherwise operate with one another. In some forms, an “injection cycle” is defined as of the steps and functions performed between commencement of injection and ejection. Upon completion of the injection cycle, a recovery profile is commenced during which the reciprocating screw 112 returns to the first position 112a.

The injection molding machine 100 also includes a controller 140 communicatively coupled with the machine 100 via connection 145. The connection 145 may be any type of wired and/or wireless communications protocol adapted to transmit and/or receive electronic signals. In these examples, the controller 140 is in signal communication with at least one sensor, such as, for example, sensor 128 located in or near the nozzle 116 and/or a sensor 129 located in or near the mold cavity 122. In some examples, the sensor 128 is located at a leading end of the screw 112 and the sensor 129 is located in a manifold or a runner of the injection machine 100. Alternatively, the sensor 128 may be located at any position ahead of the check ring of the screw 112. It is understood that any number of additional real and/or virtual sensors capable of sensing any number of characteristics of the mold 118 and/or the machine 100 may be used and placed at desired locations of the machine 100. As a further example, any type of sensor capable of detecting flow front progression in the mold cavity 122 may be used.

The controller 140 can be disposed in a number of positions with respect to the injection molding machine 100. As examples, the controller 140 can be integral with the machine 100, contained in an enclosure that is mounted on the machine, contained in a separate enclosure that is positioned adjacent or proximate to the machine, or can be positioned remote from the machine. In some embodiments, the controller 140 can partially or fully control functions of the machine via wired and/or wired signal communications as known and/or commonly used in the art.

The sensor 128 may be any type of sensor adapted to measure (either directly or indirectly) one or more characteristics of the molten plastic material 114 and/or portions of the machine 100. The sensor 128 may measure any characteristics of the molten plastic material 114 that are known and used in the art, such as, for example, a back pressure, temperature, viscosity, flow rate, hardness, strain, optical characteristics such as translucency, color, light refraction, and/or light reflection, or any one or more of any number of additional characteristics which are indicative of these. The sensor 128 may or may not be in direct contact with the molten plastic material 114. In some examples, the sensor 128 may be adapted to measure any number of characteristics of the injection molding machine 100 and not just those characteristics pertaining to the molten plastic material 114. As an example, the sensor 128 may be a pressure transducer that measures a melt pressure (during the injection cycle) and/or a back pressure (during the extrusion profile and/or recovery profile) of the molten plastic material 114 at the nozzle 116. In yet other examples, the sensor 128 may be a count sensor that measures the number of shots or times the reciprocating screw 112 has advanced.

The sensor 128 generates a signal which is transmitted to an input of the controller 140. If the sensor 128 is not located within the nozzle 116, the controller 140 can be set, configured, and/or programmed with logic, commands, and/or executable program instructions to provide appropriate correction factors to estimate or calculate values for the measured characteristic in the nozzle 116. For example, as previously noted, the sensor 128 may be programmed to measure a back pressure during a recovery profile. The controller 140 may receive these measurements and may translate the measurements to other characteristics of the molten plastic material 114, such as a viscosity value.

Similarly, the sensor 129 may be any type of sensor adapted to measure (either directly or indirectly) one or more characteristics of the molten plastic material 114 to detect its presence and/or condition in the mold cavity 122. In various embodiments, the sensor 129 may be located at or near an end-of-fill position in the mold cavity 122. The sensor 129 may measure any number of characteristics of the molten plastic material 114 and/or the mold cavity 122 that are known in the art, such as pressure, temperature, viscosity, flow rate, hardness, strain, optical characteristics such as translucency, color, light refraction, and/or light reflection, and the like, or any one or more of any number of additional characteristics indicative of these. The sensor 129 may or may not be in direct contact with the molten plastic material 114. As an example, the sensor 129 may be a pressure transducer that measures a cavity pressure of the molten plastic material 114 within the cavity 122. In yet other examples, the sensor 128 may be a count sensor that measures the number of shots or times the reciprocating screw 112 has advanced. The sensor 129 generates a signal which is transmitted to an input of the controller 140. Any number of additional sensors may be used to sense and/or measure operating parameters.

The controller 140 is also in signal communication with a screw control 126. In some embodiments, the controller 140 generates a signal which is transmitted from an output of the controller 140 to the screw control 126. The controller 140 can control any number of characteristics of the machine, such as injection pressures (by controlling the screw control 126 to advance the screw 112 at a rate which maintains a desired value corresponding to the molten plastic material 114 in the nozzle 116), barrel temperatures, clamp closing and/or opening speeds, cooling time, inject forward time, overall cycle time, pressure set points, ejection time, screw recovery speed, back pressure values exerted on the screw 112, and screw velocity.

The signal or signals from the controller 140 may generally be used to control operation of the molding process such that variations in material viscosity, mold temperatures, melt temperatures, and other variations influencing filling rate are taken into account by the controller 140. Alternatively or additionally, the controller 140 may make necessary adjustments in order to control for material characteristics such as volume and/or viscosity. Adjustments may be made by the controller 140 in real time or in near-real time (that is, with a minimal delay between sensors 128, 129 sensing values and changes being made to the process), or corrections can be made in subsequent cycles. Furthermore, several signals derived from any number of individual cycles may be used as a basis for making adjustments to the molding process. The controller 140 may be connected to the sensors 128, 129, the screw control 126, and or any other components in the machine 100 via any type of signal communication approach known in the art.

The controller 140 includes software 141 adapted to control its operation, any number of hardware elements 142 (such as, for example, a non-transitory memory module and/or processors), any number of inputs 143, any number of outputs 144, and any number of connections 145. The software 141 may be loaded directly onto a non-transitory memory module of the controller 140 in the form of a non-transitory computer readable medium, or may alternatively be located remotely from the controller 140 and be in communication with the controller 140 via any number of controlling approaches. The software 141 includes logic, commands, and/or executable program instructions which may contain logic and/or commands for controlling the injection molding machine 100 according to a mold cycle. The software 141 may or may not include an operating system, an operating environment, an application environment, and/or a user interface.

The hardware 142 uses the inputs 143 to receive signals, data, and information from the injection molding machine being controlled by the controller 140. The hardware 142 uses the outputs 144 to send signals, data, and/or other information to the injection molding machine. The connection 145 represents a pathway through which signals, data, and information can be transmitted between the controller 140 and its injection molding machine 100. In various embodiments this pathway may be a physical connection or a non-physical communication link that works analogous to a physical connection, direct or indirect, configured in any way described herein or known in the art. In various embodiments, the controller 140 can be configured in any additional or alternate way known in the art.

The connection 145 represents a pathway through which signals, data, and information can be transmitted between the controller 140 and the injection molding machine 100. In various embodiments, these pathways may be physical connections or non-physical communication links that work analogously to either direct or indirect physical connections configured in any way described herein or known in the art. In various embodiments, the controller 140 can be configured in any additional or alternate way known in the art.

In some examples, the controller 140 may determine whether the injection molding machine 100 has been inoperable for a designated period of time. For example, the controller 140 may include a dwell timer that begins after the completion of an injection cycle (e.g., after the mold cavity 122 has opened). The desired threshold time may be selectively input by a user based on their particular environment. In these examples, if the length or duration of time since the injection molding machine 100 has completed an injection cycle exceeds a threshold value (e.g., more than approximately two minutes, more than approximately five minutes, more than approximately 10 minutes, more than approximately one hour etc.), upon the injection molding machine 100 resuming operation to inject subsequent shots of molten polymer 114 into the mold cavity 122, the controller 140 commences a startup profile. It is appreciated that the threshold value may vary based on the type of injection molding machine 100 and/or the material being injected.

During the startup profile, any number of characteristics of the injection cycle are modified compared to a primary injection profile to avoid damaging the injection molding machine 100 or mold cavity 122, to ensure proper operation of the injection molding machine 100, to form high quality parts, and/or for any number of additional reasons. For example, during the startup profile, the controller 140 may cause the injection molding machine 100 to operate at a modified injection pressure, modified screw velocity, modified injection time, modified process factor A, and the like. Any number of additional parameters may be modified as desired.

In some examples, the startup profile may operate according to fixed or static parameters. For example, a user may program the controller 140 to execute the startup profile for a fixed number of shots (e.g., two shots, five shots, six shots, 10 shots, 20 shots etc.) and may designate the desired operational parameters for each of these shots. In some examples, the operational parameters may be varied during successive shots, and the operational parameters may be distinct and pre-determined. For example, in a first shot of the startup profile, the controller 140 may cause the injection molding machine 100 to operate at a first injection pressure, and in a subsequent shot of the startup profile, the controller 140 may cause the injection molding machine 100 to operate at a second injection pressure, thereby allowing the injection molding machine 100 to “ramp up” to the desired operational parameters. In some examples, the successive shots may be injected according to distinct, pre-determined injection velocity or injection pressure setpoints. Other examples are possible.

During the startup profile, the sensor or sensors 128, 129 measure at least one variable (e.g., a number of shots performed in the startup profile, a cavity pressure, a virtual cavity pressure, a time required to reach the designated cavity pressure or virtual cavity pressure, etc.). The sensed variable or variables may be indicative of whether the injection molding machine 100 is ready to and/or capable of operation according to its primary injection profile (i.e., according to normal operating parameters). Accordingly, the controller 140 may receive these sensed values after each shot is performed according to the startup profile and compare them with designated threshold values. If the sensed value is less than the threshold value, the controller 140 may continue to cause the injection molding machine 100 to operate according to the startup profile. However, if the sensed value exceeds the threshold value, the controller 140 then terminates the startup profile and causes the injection molding machine 100 to inject the molten polymer according to the primary injection profile.

In examples where the startup profile operates according to fixed or static parameters, the controller 140 may cause the injection molding machine 100 to perform the required number of shots (e.g., two shots, five shots, six shots, ten shots, etc.) and subsequently compare the sensed variable with the threshold value. As before, if the sensed value exceeds the threshold value, the controller 140 then terminates the startup profile and causes the injection molding machine 100 to inject the molten polymer according to the primary injection profile. In other examples, the controller 140 may compare the sensed value after each successive shot and may not wait until all of the designated shots are injected. As such, in some examples, the controller 140 may terminate the startup profile early if the threshold value is exceeded, meaning the injection molding machine 100 is ready for normal operation.

In some examples, the startup profile may operate according to dynamic, logic-based parameters. For example, the controller 140 may receive variables sensed by the sensor or sensors 128, 129 and use these variables to determine operational parameters for successive shots. As such, in some examples, environmental factors can impact the conditions of startup. For example, an industrial environment lacking temperature control may have substantially different characteristics between humid summer months and dry winter months, and as such, different strategies may be applied depending on these environmental conditions. Such a system may allow the injection molding machine 100 to reach normal operation more quickly.

In any of these examples, if, after a certain number of shots are injected according to the startup profile, the value measured by the sensor or sensors 128, 129 does not meet the required threshold, the controller 140 may trigger an alarm. For example, if the sensor or sensors 128, 129 are configured to sense the time required to achieve the designated cavity pressure, and the measured time doesn't reach a certain value after a certain number of successive shots (e.g., two shots, five shots, six shots, ten shots, etc.), this may be indicative of an error. For example, check ring leakage in the screw may prevent the required threshold from being reached. In this example, the controller 140 may generate an alarm as opposed to continuing to compensate for the machine fault. Accordingly, the controller 140 will generate an alarm so a user may investigate and determine why the injection molding machine 100 has not terminated the startup profile.

In some examples, the controller 140 may use the duration of downtime of the injection molding machine 100 when determining parameters of the startup profile. For example, if the injection molding machine 100 experiences a relatively short downtime (e.g., approximately five minutes), the controller 140 may commence a startup profile having different operational parameters and/or a different number of required shots than if the injection molding machine 100 experiences a relatively longer downtime (e.g., several days). Other examples are possible.

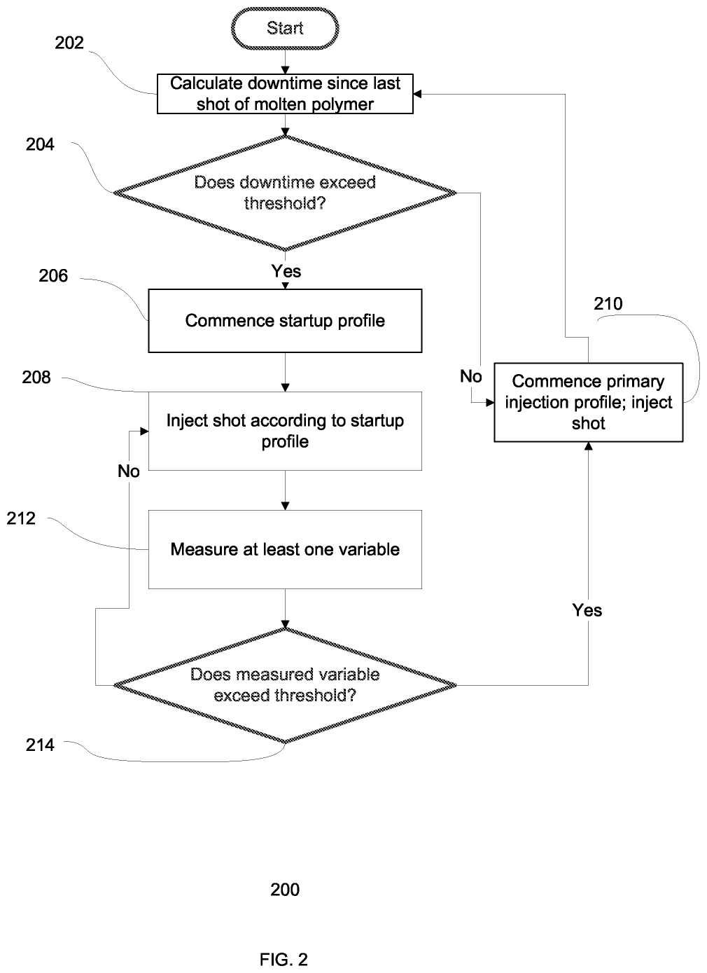

As illustrated in FIG. 2, an example process 200 incorporating a startup profile is described. First, at a step 202, a downtime since the last shot of molten polymer 114 is calculated. At a step 204, the process 200 determines whether the calculated downtime exceeds a threshold value. If the calculated downtime does not exceed the threshold value, the process 200 advances to a step 210, where a primary injection profile is commenced to inject a shot of molten polymer 114 into the mold cavity 122. If the calculated downtime does exceed the threshold value, the process 200 advances to a step 206, whereby a startup profile is commenced. At a step 208, the controller 140 causes a shot of molten polymer 114 to be injected according to the startup profile. At a step 212 at least one variable is measured. This measurement may occur during and/or after the shot is injected in the step 208. At a step 214, the process determines whether the measured variable exceeds a threshold value. If the measured variable does exceed the threshold value, the process 200 advances to the step 210, whereby the primary injection profile commences. If the measured variable does not exceed the threshold value, the process 200 returns to the step 208 whereby a shot is injected according to the startup profile.

By incorporating the approaches described herein, the machine 100 may safely operate in an efficient manner when starting up after experiencing downtime, thus reducing potentially harmful operation that may damage the machine. Additionally, in some environments, the startup profile process described herein may result in time savings while consistently producing high-quality parts.

The startup profile processes described herein may advantageously be incorporated into conventional injection molding systems, injection molding systems incorporating low, substantially constant pressure approaches, injection molding systems incorporating specialized control based on real-time viscosity measurements, and any other systems.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A method for controlling an injection molding machine having a mold forming a mold cavity, the injection molding machine being controlled according to an injection cycle, the method comprising:
injecting a molten polymer into the mold cavity according to a startup profile;
measuring, using a first sensor, at least one variable during the startup profile;
terminating the startup profile upon the at least one variable exceeding a first threshold;
injecting the molten polymer into the mold cavity according to a primary injection profile.

2. The method of claim 1, further comprising the step of:
continuing to inject the molten polymer into the mold cavity according to the startup profile if the at least one variable does not exceed the first threshold value.

3. The method of claim 1, wherein the startup profile comprises injecting a plurality of shots of molten polymer into the mold cavity, each of the plurality of injected shots being injected according to distinct, pre-determined injection velocity or injection pressure setpoints.

4. The method of claim 1, wherein the at least one variable comprises a quantity of shots of molten polymer injected into the mold cavity.

5. The method of claim 4, wherein the threshold value comprises at least two shots.

6. The method of claim 5, wherein each of the at least two shots is injected according to distinct, pre-determined injection velocity or injection pressure setpoints.

7. The method of claim 1, wherein the at least one variable comprises a time required to reach a desired operational level.

8. The method of claim 7, wherein the desired operational level comprises at least one of a cavity pressure or a virtual cavity pressure.

9. The method of claim 1, further comprising the step of:
triggering an alarm if the at least one variable fails to exceed the first threshold after a designated quantity of successive shots in the startup profile.

10. An injection molding machine comprising:
an injection unit having a mold forming a mold cavity and a screw that moves from a first position to a second position, the injection unit adapted to receive and inject a molten plastic material into the mold cavity via the screw to form a molded part;
a controller adapted to control operation of the injection molding machine according to an injection cycle;
a sensor coupled with the injection molding machine and the controller, the sensor adapted to measure at least one variable during a startup profile;
wherein the controller is adapted to:
commence injection of the molten polymer into the mold cavity according to the startup profile,
terminate the startup profile upon the at least one variable sensed by the sensor exceeding a first threshold, and
commence injection of the molten polymer into the mold cavity according to a primary injection profile.

11. The injection molding machine of claim 10, wherein the controller is further adapted to continue injecting the molten polymer into the mold cavity according to the startup profile if the at least one variable does not exceed the first threshold.

12. The injection molding machine of claim 10, wherein the startup profile comprises injecting a plurality of shots of molten polymer into the mold cavity, each of the plurality of injected shots being injected according to distinct, pre-determined injection velocity or injection pressure setpoints.

13. The injection molding machine of claim 10, wherein the at least one variable comprises a quantity of shots of molten polymer injected into the mold cavity.

14. The injection molding machine of claim 13, wherein the threshold value comprises at least two shots.

15. The injection molding machine of claim 14, wherein each of the at least two shots is injected according to distinct, pre-determined injection velocity or injection pressure setpoints.

16. The injection molding machine of claim 10, wherein the at least one variable comprises a time required to reach a desired operational level.

17. The injection molding machine of claim 16, wherein the desired operational level comprises at least one of a cavity pressure or a virtual cavity pressure.

18. The injection molding machine of claim 10, wherein the controller is further adapted to trigger an alarm if the at least one variable fails to exceed the first threshold after a designated quantity of successive shots in the startup profile.

19. A method for controlling an injection molding machine having a mold forming a mold cavity, the injection molding machine being controlled according to an injection cycle, the method comprising:
determining a duration of downtime of the injection molding machine;
configuring the injection molding machine to operate according to a startup profile according to the duration of downtime;
injecting a molten polymer into the mold cavity according to the startup profile;
measuring, via a first sensor, at least one variable during the startup profile;
determining whether the at least one variable exceeds a threshold value; and
if the at least one variable exceeds the threshold value, terminating the startup profile.

20. The method of claim 19, further comprising the step of injecting the molten polymer into the mold cavity according to a primary injection profile upon terminating the startup profile.

21. The method of claim 19, further comprising the step of:
continuing to inject the molten polymer into the mold cavity according to the startup profile if the at least one variable does not exceed the first threshold value.

22. The method of claim 19, wherein the at least one variable comprises a quantity of shots of molten polymer injected into the mold cavity.

23. The method of claim 19, wherein the at least one variable comprises a time required to reach a desired operational level.

24. The method of claim 23, wherein the desired operational level comprises at least one of a cavity pressure or a virtual cavity pressure

25. A non-transitory computer-readable storage medium storing processor-executable instructions that, when executed, cause one or more processors to:
inject a molten polymer into the mold cavity according to a startup profile;
measure, using a first sensor, at least one variable during the startup profile;
terminate the startup profile upon the at least one variable exceeding a first threshold; and
inject the molten polymer into the mold cavity according to a primary injection profile.
